(19) United States
(12) Patent Application Publication
(10) Pub. No.: US 2026/0116182 A1
(43) Pub. Date: Apr. 30, 2026

(54) Cover Assembly

(71) Applicant: Illinois Tool Works Inc., Glenview, IL (US)

(72) Inventor: Yuan Sun, Shanghai (CN)

(21) Appl. No.: 19/367,475

(22) Filed: Oct. 23, 2025

(30) Foreign Application Priority Data
Oct. 20, 2025 (CN) 202511499874.0
Oct. 25, 2024 (CN) 202411505443.6

(51) Int. Cl. B60K 15/05; B60L 53/16

(52) U.S. Cl. CPC B60K 15/05; B60L 53/16; B60K 2015/0515

(57) ABSTRACT

The present application provides a cover assembly comprising a housing, a cover and a cover pusher. The housing has a housing opening and has a height direction and a depth direction. The housing defines a first track groove. The cover is coupled to the housing through the first track groove and is configured to move along the height direction and the depth direction between a closed position and an open position under the guidance of the first track groove to close or open the housing opening. The cover pusher is provided with an operation structure and is operatively connected to the cover through the operation structure to push the cover to move between the closed position and the open position under the drive of a drive device. The first track groove comprises a first limit groove segment configured to prevent the cover from moving along the height direction of the housing under an external force when the cover is in the closed position. The operation structure is configured to prevent the cover from moving along the depth direction of the housing under an external force when the cover is in the closed position.

### RELATED APPLICATIONS

The present application claims the benefit of Chinese Patent Application Nos. 202411505443.6, filed October 25, 2024, and 202511499874.0, filed October 20, 2025, each titled “Cover Assembly,” the contents of which are hereby incorporated by reference.

### TECHNICAL FIELD

This application relates to a cover assembly, in particular to a cover assembly for use in a vehicle.

### BACKGROUND

Cover assemblies for vehicles are used, for example, for fuel filler openings or charging ports of vehicles. The cover of the cover assembly closes or opens an opening on the vehicle as needed. In some existing cover assemblies, the cover of the cover assembly rotates between a closed position and an open position to close or open the opening on the vehicle. Furthermore, in some existing cover assemblies, the cover assembly includes a base (such as a charging socket) for connecting to an external device (for example, a charging gun).

### SUMMARY

The present disclosure generally relates to a cover assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a schematic perspective view of a cover assembly according to an exemplary embodiment of the present application.

FIG. 1B is a schematic exploded view of the cover assembly in FIG. 1A, in which the drive device is omitted.

FIG. 1C is a schematic rear perspective view of the cover pusher shown in FIG. 1B.

FIG. 2A is a schematic side view of the cover assembly in FIG. 1A in a first state, in which the cover pusher is not driven to rotate, and the cover is in a closed position.

FIG. 2B is a schematic side view of the cover assembly in FIG. 1A in a second state, in which the cover pusher has been driven to rotate, and the cover is in an intermediate position.

FIG. 2C is a schematic side view of the cover assembly in FIG. 1A in a third state, in which the cover pusher is further driven to rotate, and the cover reaches an open position.

FIG. 3 is a schematic perspective view of a cover pusher according to another exemplary embodiment of the present application.

FIG. 4A is a schematic side view of a cover assembly according to another exemplary embodiment employing the cover pusher shown in FIG. 3 in a first state, in which the cover pusher is not driven to rotate, and the cover is in a closed position.

FIG. 4B is a schematic side view of the cover assembly in FIG. 4A in a second state, in which the cover pusher has been driven to rotate, and the cover is in an intermediate position.

FIG. 4C is a schematic side view of the cover assembly in FIG. 4A in a third state, in which the cover pusher is further driven to rotate, and the cover reaches an open position.

FIG. 5A is a schematic front perspective view of a cover assembly according to yet another exemplary embodiment of the present application.

FIG. 5B is a schematic rear perspective view of the cover assembly in FIG. 5A, in which the housing is omitted.

FIG. 5C is a schematic exploded view of the cover assembly in FIG. 5A, in which the drive device is omitted.

FIG. 6A is a schematic side view of the cover assembly in FIG. 5A in a first state, in which a base pusher is not driven to rotate, and the base is in a retracted position.

FIG. 6B is a schematic side view of the cover assembly in FIG. 5A in a second state, in which the base pusher has been driven to rotate but the base remains in the retracted position.

FIG. 6C is a schematic side view of the cover assembly in FIG. 5A in a third state, in which the base pusher has been further driven to rotate, and the base reaches an extended position.

FIG. 6D is a schematic side view of the cover assembly in FIG. 5A in a fourth state, in which the base pusher has been still further driven to rotate, and the base is maintained in the extended position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been discovered that when the cover of the cover assembly is in the closed position, the cover may undergo undesired movement due to an external force, resulting in the cover failing to remain in the closed position. Moreover, the inventor of the present application has also found that the base (e.g., charging socket) of the cover assembly is fixedly arranged in the cover assembly and is immovable, and its position is usually at a certain distance from the opening on the vehicle. This makes it inconvenient to connect an external device (e.g., a charging gun) to the base.

To at least partially solve these technical problems, according to a first aspect of the present application, a cover assembly is provided, which comprises a housing, a cover and a cover pusher. The housing has a housing opening and has a height direction and a depth direction. The housing defines a first track groove. The cover is coupled to the housing through the first track groove and is configured to move along the height direction and the depth direction between a closed position and an open position under the guidance of the first track groove to close or open the housing opening. The cover pusher is provided with an operation structure and is operatively connected to the cover through the operation structure to push the cover to move between the closed position and the open position under the drive of a drive device. The first track groove comprises a first limit groove segment configured to prevent the cover from moving along the height direction of the housing under an external force when the cover is in the closed position. The operation structure is configured to prevent the cover from moving along the depth direction of the housing under an external force when the cover is in the closed position.

In some embodiments, the first track groove further comprises a first guide groove segment connected to the first limit groove segment and configured to guide the cover to rotate relative to the housing.

In some embodiments, the first limit groove segment extends substantially along the depth direction of the housing, and the first guide groove segment is an arc-shaped groove.

In some embodiments, the cover comprises a mounting portion and the cover is operatively connected to the operation structure of the cover pusher through the mounting portion; and a main body portion connected to the mounting portion and shape-matched to the housing opening.

In some embodiments, the housing is provided with a support shaft, and the cover pusher is rotatably supported on the housing through the support shaft. The mounting portion of the cover is provided with a receiving groove in which the support shaft is received. The receiving groove extends a certain length in a radial direction of the support shaft to allow the cover to move relative to the housing.

In some embodiments, the mounting portion of the cover is further provided with a cover guide pin. The cover guide pin is received in the first track groove and is operatively connected to the operation structure of the cover pusher. When the cover is in the closed position, the cover guide pin is located in the first limit groove segment of the housing, and when the cover is in the open position, the cover guide pin is located in the first guide groove segment of the housing.

In some embodiments, the operation structure comprises a second track groove. The second track groove receives the cover guide pin and has a second limit groove segment and a second guide groove segment connected to each other. When the cover is in the closed position, the cover guide pin is located in the second limit groove segment, and when the cover is in the open position, the cover guide pin is located in the second guide groove segment.

In some embodiments, the second limit groove segment extends substantially along the height direction of the housing. The second guide groove segment extends from the second limit groove segment in a direction away from the housing opening to allow the cover guide pin to move from the first limit groove segment of the housing towards the first guide groove segment of the housing under the drive of the drive device.

In some embodiments, the operation structure comprises an operation lever. The operation lever is rotatably connected to the cover pusher via a connection pin and is fixedly connected to the cover guide pin. When the cover is in the closed position, the central axes of the support shaft, the connection pin and the cover guide pin are substantially located at the same position in the height direction of the housing to prevent the cover from moving along the depth direction of the housing under an external force.

In some embodiments, the cover assembly further comprises a base rotatably mounted to the housing about a base shaft to have an extended position and a retracted position relative to the housing opening.

In some embodiments, the cover assembly further comprises a base pusher operatively connected to the drive device and the base to rotate relative to the housing simultaneously with the cover pusher under the drive of the drive device and to push the base to rotate.

In some embodiments, the base pusher is provided with a third track groove comprising a drive groove segment and the base is provided with a base guide pin. The base guide pin is received in the third track groove and cooperates with the drive groove segment to enable the base pusher to push the base to rotate.

In some embodiments, the third track groove further comprises a third limit groove segment connected to one end of the drive groove segment. The third limit groove segment is configured to prevent the base from rotating relative to the housing under an external force when the base is in the extended position.

In some embodiments, when the base is in the extended position, an extension direction of the third limit groove segment substantially passes through the central axes of the base guide pin and the base shaft.

In some embodiments, the third track groove further comprises a third guide groove segment connected to the other end of the drive groove segment. The third guide groove segment is configured to guide the base guide pin to slide therein when the base pusher is driven to rotate by the drive device while the base remains stationary relative to the housing.

In some embodiments, the cover assembly comprises the drive device mounted to the housing.

According to a second aspect of the present application, a cover assembly is provided, which comprises a housing, a base and a base pusher. The housing has a housing opening. The base is rotatably mounted to the housing about a base shaft to have an extended position and a retracted position relative to the housing opening. The base pusher is operatively connected to the base to push the base to rotate under the drive of a drive device.

In some embodiments, the base pusher is provided with a third track groove comprising a drive groove segment and the base is provided with a base guide pin. The base guide pin is received in the third track groove and cooperates with the drive groove segment to enable the base pusher to push the base to rotate.

In some embodiments, the third track groove further comprises a third limit groove segment connected to one end of the drive groove segment. The third limit groove segment is configured to prevent the base from rotating relative to the housing under an external force when the base is in the extended position.

In some embodiments, when the base is in the extended position, an extension direction of the third limit groove segment substantially passes through the central axes of the base guide pin and the base shaft.

The structure of the cover assembly of the present application avoids undesired movement of the cover under an external force when in its closed position, thereby allowing the cover to remain in its closed position. The term “external force” as used in the present application refers to a force other than that from a drive device, such as pressing by a human hand, and may be applied to the cover in any direction.

In the cover assembly of the present application, the base is movable between an extended position and a retracted position. When it is necessary to connect an external device to the base, the base is driven to its extended position to facilitate connection with the external device. When it is unnecessary to connect an external device to the base, the base is driven back to its retracted position.

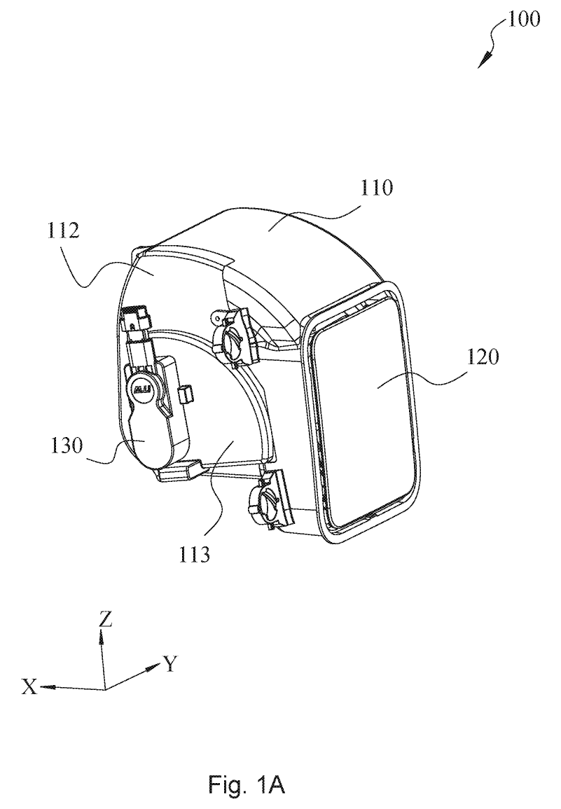

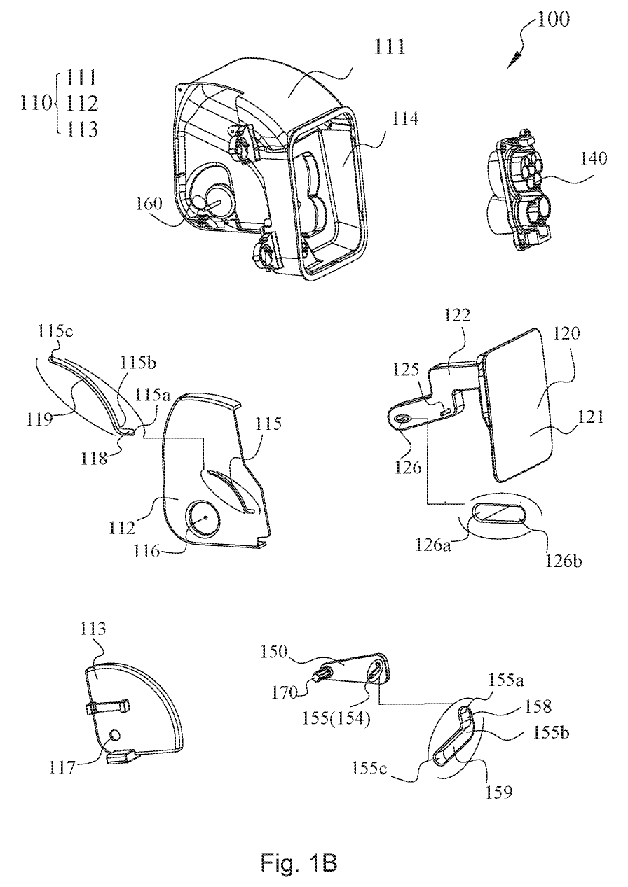

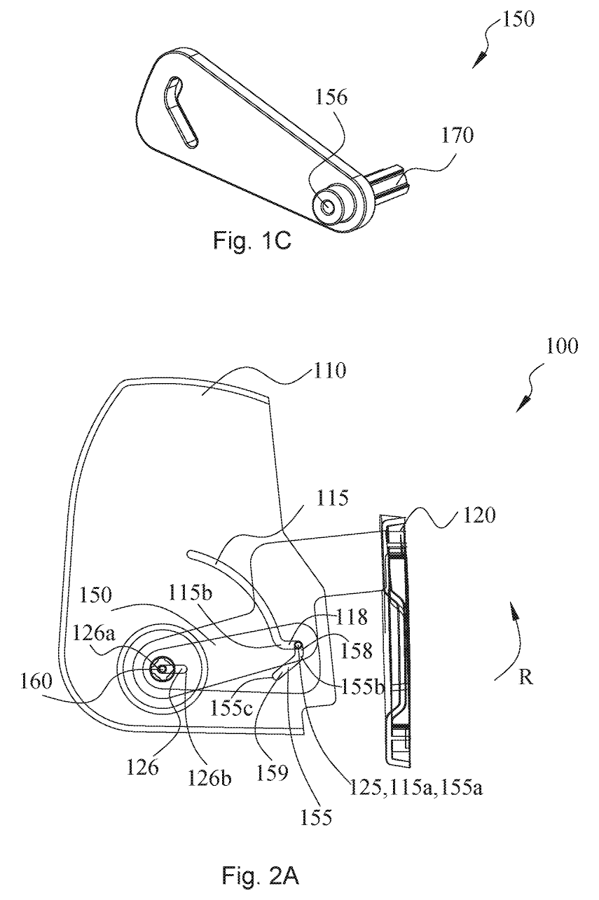

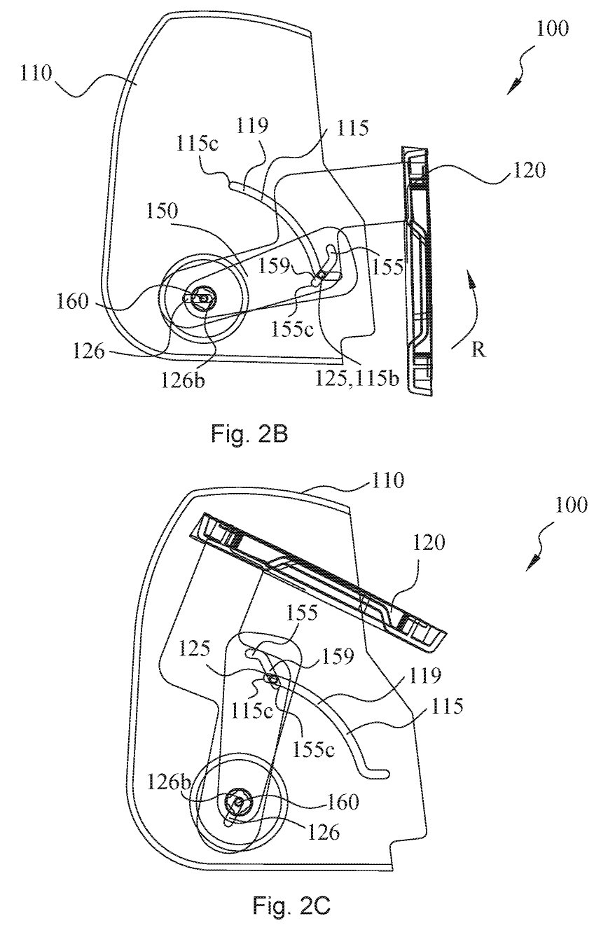

FIGS. 1A to 2C relate to a cover assembly 100 according to an exemplary embodiment of the present application. FIGS. 1A to 1C show a schematic overall structure of the cover assembly 100. FIGS. 2A to 2C schematically show the process of the cover 120 of the cover assembly 100 moving from a closed position to an open position.

FIG. 1A is a schematic perspective view of the cover assembly 100. FIG. 1B is a schematic exploded view of the cover assembly 100, in which the drive device 130 is omitted in FIG. 1B. FIG. 1C is a schematic rear perspective view of the cover pusher 150 in the cover assembly 100.

As shown in FIGS. 1A to 1B, the cover assembly 100 includes a housing 110, a cover 120, a drive device 130, a base 140, a cover pusher 150, a support shaft 160, and a drive shaft 170. The housing 110 has a housing opening 114 and has a depth direction (X), a width direction (Y), and a height direction (Z). The cover 120 is coupled to the housing 110 and is movable along the height direction and the depth direction of the housing between a closed position and an open position to close or open the housing opening 114. The drive device 130 is mounted on the housing 110 to drive the cover 120 to move. In other embodiments, the drive device 130 may be provided independently of the cover assembly 100 but not mounted to the housing 110. The base 140 is mounted in the housing 110. The base 140 shown in the figure is a charging socket for connecting with a charging gun. In other embodiments, the base 140 may be other components for connecting with other external devices. The cover pusher 150 is operatively connected to the cover 120. The support shaft 160 is fixedly disposed on the housing 110, and the cover pusher 150 is rotatably supported on the housing 110 via the support shaft 160. The support shaft 160 shown in the figure is in the form of a pin. The drive shaft 170 is connected to the drive device 130 at one end and rotates under the drive of the drive device 130. The drive shaft 170 is fixedly connected to the cover pusher 150 at the other end, so that the cover pusher 150 pushes the cover 120 to move between the closed position and the open position under the drive of the drive device 130.

Referring to FIG. 1B, the housing 110 includes a main housing 111, a first side cover plate 112, and a second side cover plate 113. The first side cover plate 112 is connected to the side of the main housing 111. The second side cover plate 113 is disposed outside the first side cover plate 112. The first side cover plate 112 is spaced apart from the main housing 111 to rotatably accommodate a mounting portion 122 of the cover 120 therebetween (not shown), thereby preventing the cover 120 from moving along the width direction of the housing 110. The first side cover plate 112 is spaced apart from the second side cover plate 113, and the cover pusher 150 is rotatably disposed therebetween. The second side cover plate 113 is provided with a drive shaft hole 117, and the drive shaft 170 passes through the drive shaft hole 117 to connect to the drive device 130. It should be understood that in other embodiments, the main housing 111, the first side cover plate 112, and the second side cover plate 113 may be integrally constructed.

The first side cover plate 112 is provided with a support shaft hole 116. The support shaft 160 passes the first side cover plate 112 through the support shaft hole 116 and is coupled to the cover pusher 150. The first side cover plate 112 defines a first track groove 115. The cover 120 is coupled to the housing 110 through the first track groove 115, and is movable along the height direction and the depth direction of the housing 110 between the closed position and the open position under the guidance of the first track groove 115.

The first track groove 115 extends between a first end 115a and a second end 115c, and includes a first limit groove segment 118 and a first guide groove segment 119 which are connected to each other at a connection point 115b. The first limit groove segment 118 extends substantially in the depth direction of the housing 110, so that when the cover 120 is in the closed position, the first limit groove segment 118 can prevent the cover 120 from moving along the height direction of the housing 110 under an external force. In the embodiment shown in the figure, the first limit groove segment 118 is a linear groove extending substantially in the depth direction of the housing 110. It should be understood that in other embodiments, the first limit groove segment 118 may also have other shapes, such as an arc-shaped groove. The first guide groove segment 119 guides the rotation of the cover 120 relative to the housing 110. In the embodiment shown in the figure, the first guide groove segment 119 is an arc-shaped groove.

Referring to FIG. 1B, the cover 120 includes a main body portion 121 and a mounting portion 122. The main body portion 121 is shape-matched to the housing opening 114 so as to be able to close the housing opening 114. In the embodiment shown in the figure, the main body portion 121 is a substantially rectangular plate. The mounting portion 122 is connected to the main body portion 121 and is rotatably disposed between the main housing 111 and the first side cover plate 112 of the housing 110.

Continuing to refer to FIG. 1B, the mounting portion 122 is provided with a receiving groove 126, and the support shaft 160 is received in the receiving groove 126. The receiving groove 126 extends a certain length in the radial direction of the support shaft 160 and thus has a first end 126a and a second end 126b, allowing the cover 120 to move relative to the housing 110 along the depth direction of the housing 110. When the cover 120 moves along the depth direction of the housing 110 under the guidance of the first limit groove segment 118 of the first track groove 115, the receiving groove 126 moves relative to the support shaft 160, causing the support shaft 160 to move between the first end 126a and the second end 126b of the receiving groove 126. In the embodiment shown in the figure, the receiving groove 126 is shown as a linear groove and extends substantially in the depth direction of the housing 110 when the cover 120 is in the closed position. It should be understood that in other embodiments, the receiving groove 126 may have other shapes, provided that the shape of the receiving groove 126 matches the first limit groove segment 118 on the housing 110 to enable the cover 120 to move from the first limit groove segment 118 to the first guide groove segment 119 of the housing 110 under the drive of the drive device 130. As an example, when the first limit groove segment 118 is configured as an arc shape, the receiving groove 126 is also configured as an arc shape. The support shaft 160 can also rotate relative to the receiving groove 126, to allow the cover 120 to rotate relative to the housing 110 about the support shaft 160 under the guidance of the first guide groove segment 119 of the housing 110.

Continuing to refer to FIG. 1B, the mounting portion 122 is further provided with a cover guide pin 125. The cover guide pin 125 is received in the first track groove 115 on the housing 110 and is operatively connected to the cover pusher 150. When the cover 120 is in the closed position, the cover guide pin 125 is located in the first limit groove segment 118 of the first track groove 115, and when the cover 120 is in the open position, the cover guide pin 125 is located in the first guide groove segment 119 of the first track groove 115.

Referring to FIGS. 1B and 1C, the cover pusher 150 is fixedly connected to the drive shaft 170 at one end to rotate under the drive of the drive device 130. As shown in FIG. 1C, the cover pusher 150 is provided with a hole 156 at the other side. The hole 156 is aligned coaxially with the drive shaft 170 and rotatably receives the support shaft 160, so that the cover pusher 150 can rotate relative to the support shaft 160 under the drive of the drive device 130.

Referring to FIG. 1B, the cover pusher 150 is further provided with an operation structure 154 and is operatively connected to the cover 120 through the operation structure 154 to push the cover 120 to move between the closed position and the open position under the drive of the drive device 130. Moreover, when the cover 120 is in the closed position, the operation structure 154 can prevent the cover 120 from moving along the depth direction of the housing 110 under an external force. As shown in the figure, the operation structure 154 includes a second track groove 155, which receives the cover guide pin 125. The second track groove 155 extends from its first end 155a to its second end 155c and has a second limit groove segment 158 and a second guide groove segment 159 which are connected to each other at a connection point 155b on the second track groove 155. When the cover 120 is in the closed position, the cover guide pin 125 is located in the second limit groove segment 158, and when the cover 120 is in the open position, the cover guide pin 125 is located in the second guide groove segment 159.

The second limit groove segment 158 extends substantially along the height direction of the housing 110, so as to prevent the cover 120 from moving along the depth direction of the housing 110 under an external force when the cover 120 is in the closed position. In the embodiment shown in the figure, the second limit groove segment 158 is a linear groove extending along the height direction of the housing 110. It should be understood that in other embodiments, the second limit groove segment 158 may be configured to have other shapes, such as an arc-shaped groove. In some embodiments, the magnitude of the external force required to drive the cover 120 away from its closed position is defined by setting an angle between the second limit groove segment 158 of the second track groove 155 and the first limit groove segment 118 of the first track groove 115. In some embodiments, when the cover 120 is in the closed position, the angle between the second limit groove segment 158 of the second track groove 155 and the first limit groove segment 118 of the first track groove 115 is between 70° and 110°. In some embodiments, when the cover 120 is in the closed position, the angle between the second limit groove segment 158 of the second track groove 155 and the first limit groove segment 118 of the first track groove 115 is 90°.

The second guide groove segment 159 extends from the second limit groove segment 158 in a direction away from the housing opening 114, to allow the cover guide pin 125 to move, under the drive of the drive device 130, from the first limit groove segment 118 towards the first guide groove segment 119 on the housing 110. In the embodiment shown in the figure, the second guide groove segment 159 is a linear groove inclined relative to the depth direction of the housing 110. It should be understood that the second guide groove segment 159 may be configured in other shapes, such as a linear groove extending parallel to the depth direction of the housing, or an arc-shaped groove.

The process of the cover 120 of the cover assembly 100 moving from the closed position to the open position is described below with reference to FIGS. 2A to 2C. FIG. 2A is a schematic side view of the cover assembly 100 in a first state, in which the cover pusher 150 is not driven to rotate and the cover 120 is in the closed position. FIG. 2B is a schematic side view of the cover assembly 100 in a second state, in which the cover pusher 150 has been driven to rotate and the cover 120 is in an intermediate position. FIG. 2C is a schematic side view of the cover assembly 100 in a third state, in which the cover pusher 150 is further driven to rotate and the cover 120 reaches the open position.

As shown in FIG. 2A, when the cover 120 is in the closed position, the support shaft 160 is near the first end 126a of the receiving groove 126 on the cover 120, and the cover guide pin 125 is in the first limit groove segment 118 of the first track groove 115 on the housing 110 and in the second limit groove segment 158 of the second track groove 155 on the cover pusher 150. The figure exemplarily shows the cover guide pin 125 is at the first end 115a of the first track groove 115 and at the first end 155a of the second track groove 155.

From FIG. 2A to FIG. 2B, the cover pusher 150 is driven to rotate in a counterclockwise (arrow R) direction as shown in FIG. 2A about the support shaft 160 relative to the housing 110. The rotation process of the cover pusher 150 from FIG. 2A to FIG. 2B is divided into two stages.

In the first stage, the cover pusher 150 rotates about the support shaft 160 relative to the housing 110 to rise, causing the second limit groove segment 158 of the second track groove 155 to rise relative to the cover guide pin 125. This causes the cover guide pin 125 to move from the first end 155a of the second track groove 155 to the connection point 155b of the second track groove 155. During this first stage, the position of the cover guide pin 125 relative to the housing 110 does not change, and the cover guide pin 125 remains at the first end 115a of the first track groove 115 on the housing 110. Consequently, the cover 120 remains stationary relative to the housing 110, still in its closed position. Accordingly, the position of the support shaft 160 within the receiving groove 126 also does not change, remaining near the first end 126a of the receiving groove 126.

After the cover guide pin 125 reaches the connection point 155b of the second track groove 155, the cover pusher 150 begins the second stage of rotation. In the second stage, the cover pusher 150 continues to rotate about the support shaft 160 relative to the housing 110 to rise, causing the second guide groove segment 159 of the second track groove 155 to rise relative to the cover guide pin 125, which results that the cover guide pin 125 gradually approaches the second end 155c of the second track groove 155. This causes the cover guide pin 125 to move along the first limit groove segment 118 of the first track groove 115 towards the connection point 115b of the first track groove 115. Therefore, the cover 120 moves along the depth direction of the housing 110 towards the interior of the housing 110 under the guidance of the first limit groove segment 118. Accordingly, the receiving groove 126 on the cover 120 moves relative to the support shaft 160, causing the support shaft 160 to gradually approach the second end 126b of the receiving groove 126.

When the cover pusher 150 rotates to the position shown in FIG. 2B, the cover guide pin 125 reaches the connection point 115b on the first track groove 115 and reaches a position near the second end 155c of the second track groove 155. The cover 120 has moved inward by a distance along the depth direction of the housing 110 relative to its closed position, reaching an intermediate position. Accordingly, the support shaft 160 reaches a position near the second end 126b of the receiving groove 126.

From FIG. 2B to FIG. 2C, the cover pusher 150 continues to be driven to rotate in a counterclockwise (arrow R) direction as shown in FIG. 2B about the support shaft 160 relative to the housing 110. As the cover pusher 150 rotates, the cover guide pin 125 moves along the first guide groove segment 119 of the first track groove 115 on the housing 110, causing the cover 120 to rotate relative to the housing 110. During this process, the position of the cover guide pin 125 within the second track groove 155 of the cover pusher 150 remains unchanged, and the position of the support shaft 160 within the receiving groove 126 remains unchanged.

When the cover pusher 150 rotates to the position shown in FIG. 2C, the cover 120 reaches the open position. At this time, the cover guide pin 125 is located in the first guide groove segment 119 of the first track groove 115 on the housing 110 and in the second guide groove segment 159 of the second track groove 155 on the cover pusher 150. The figure exemplary shows the cover guide pin 125 near the second end 115c of the first track groove 115 and near the second end 155c of the second track groove 155. The support shaft 160 is located near the second end 126b of the receiving groove 126.

As shown in FIGS. 2A to 2C, the process of the cover 120 moving from the closed position to the open position involves movements in two directions, including movement along the depth direction of the housing 110 and rotation relative to the housing 110, respectively under the guidance of the first limit groove segment 118 and the first guide groove segment 119 of the first track groove 115 on the housing 110. Since, in the embodiment shown in the figure, the first limit groove segment 118 of the first track groove 115 is a linear groove along the depth direction of the housing 110, the movement of the cover 120 along the depth direction of the housing 110 is a translational motion. It should be understood that in other embodiments, the cover 120 may perform different forms of movement along the depth direction of the housing 110. For example, if the first track groove 115 is an arc-shaped groove along the depth direction of the housing 110, the movement of the cover 120 along the depth direction of the housing 110 takes the form of rotation relative to the housing 110.

It should be understood that when the cover assembly 100 performs the action process from FIG. 2C to FIG. 2A, the cover 120 moves from the open position to the closed position.

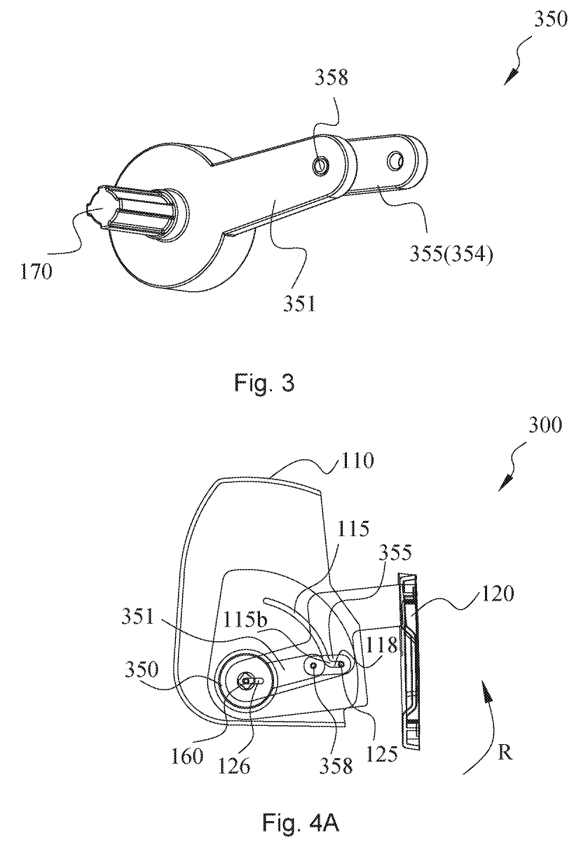

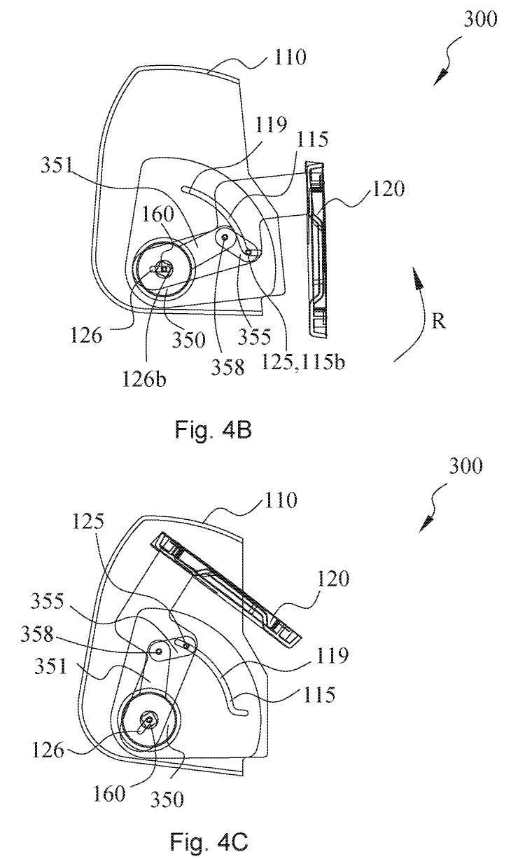

FIGS. 3 to 4C relate to a cover assembly 300 according to another exemplary embodiment of the present application. The cover assembly 300 differs from the aforementioned cover assembly 100 only in the operation structure 354 of the cover pusher 350. FIG. 3 shows a schematic perspective view of the cover pusher 350 of the cover assembly 300. FIGS. 4A to 4C schematically show the process of the cover 120 of the cover assembly 300 moving from a closed position to an open position. For the sake of brevity, only the difference of the structures of the cover assembly 300 and the cover assembly 100, namely the operation structure 354 of the cover pusher 350, will be described.

The operation structure 354 of the cover pusher 350 includes an operation lever 355. The operation lever 355 is rotatably connected to the cover pusher 350, and the cover pusher 350 is operatively connected to the cover 120 via the operation lever 355. Specifically, as shown in FIG. 3, the cover pusher 350 includes a body 351 and the operation lever 355. The operation lever 355 is rotatably connected to the body 351 of the cover pusher 350 at one end via a connection pin 358, and is fixedly connected to the cover guide pin 125 on the cover 120 at the other end. When the cover pusher 350 is driven to rotate about the support shaft 160, the cover 120 moves relative to the housing 110 through the cooperation of the cover guide pin 125 and the operation lever 355 with the first track groove 115 on the housing 110.

The process of the cover 120 in the cover assembly 300 moving from the closed position to the open position is described with reference to FIGS. 4A to 4C. FIG. 4A is a schematic side view of the cover assembly 300 in a first state, in which the cover pusher 350 is not driven to rotate and the cover 120 is in the closed position. FIG. 4B is a schematic side view of the cover assembly 300 in a second state, in which the cover pusher 350 has been driven to rotate and the cover 120 is in an intermediate position. FIG. 4C is a schematic side view of the cover assembly 300 in a third state, in which the cover pusher 350 is further driven to rotate and the cover 120 reaches the open position. For the sake of brevity, the differences between the movement process shown in FIGS. 4A to 4C and the movement process in FIGS. 2A to 2C are primarily described. Details in FIGS. 4A to 4C that are the same as those shown in FIGS. 2A to 2C are only briefly described, and the omitted descriptions for FIGS. 4A to 4C can be referred to in the descriptions regarding FIGS. 2A to 2C.

As shown in FIG. 4A, when the cover 120 is in the closed position, the central axes of the support shaft 160, the connection pin 358, and the cover guide pin 125 are substantially located at the same position in the height direction of the housing 110. This enables prevention of the cover 120 from moving along the depth direction of the housing 110 under an external force.

During the process from FIG. 4A to FIG. 4B, when the cover pusher 350 is driven to rotate, the body 351 of the cover pusher 350 rotates about the support shaft 160 in the counterclockwise direction (arrow R) as shown in the figure. Through the cooperation of the cover guide pin 125 with the first limit groove segment 118 of the first track groove 115, the rotation of the body 351 of the cover pusher 350 causes the operation lever 355 of the cover pusher 350 to rotate about the connection pin 358 relative to the body 351, thereby pushing the cover guide pin 125 to move along the first limit groove segment 118. Consequently, the cover 120 moves along the depth direction of the housing 110 towards the interior of the housing 110 under the guidance of the first limit groove segment 118. Accordingly, the support shaft 160 moves within the receiving groove 126 on the cover 120.

FIG. 4B shows that the cover guide pin 125 has reached the connection point 115b on the first track groove 115, the support shaft 160 is near the second end 126b of the receiving groove 126, and the cover 120 has moved a distance towards the interior of the housing 110, reaching an intermediate position.

From FIG. 4B to FIG. 4C, the body 351 of the cover pusher 350 continues to be driven to rotate in a counterclockwise direction about the support shaft 160. As the body 351 of the cover pusher 350 continues to rotate, the operation lever 355 rotates relative to the housing 110 under the guidance of the first guide groove segment 119 of the first track groove 115 and pushes the cover guide pin 125 to move along the first guide groove segment 119. Consequently, the cover 120 rotates relative to the housing 110 and reaches the open position as shown in FIG. 4C. During the process from FIG. 4B to FIG. 4C, the operation lever 355 of the cover pusher 350 does not rotate about the connection pin 358 and thus remains stationary relative to the body 351. Furthermore, during the process from FIG. 4B to FIG. 4C, the position of the support shaft 160 within the receiving groove 126 remains unchanged.

As described above, in the cover assembly 300, during the process of the cover 120 moving from its closed position to its open position in the sequence from FIG. 4A to FIG. 4C, the cover 120 undergoes movements in two directions similar to those in the movement process from FIGS. 2A to 2C.

It should be understood that when the cover assembly 300 executes the action process from FIG. 4C to FIG. 4A, the cover 120 moves from the open position to the closed position.

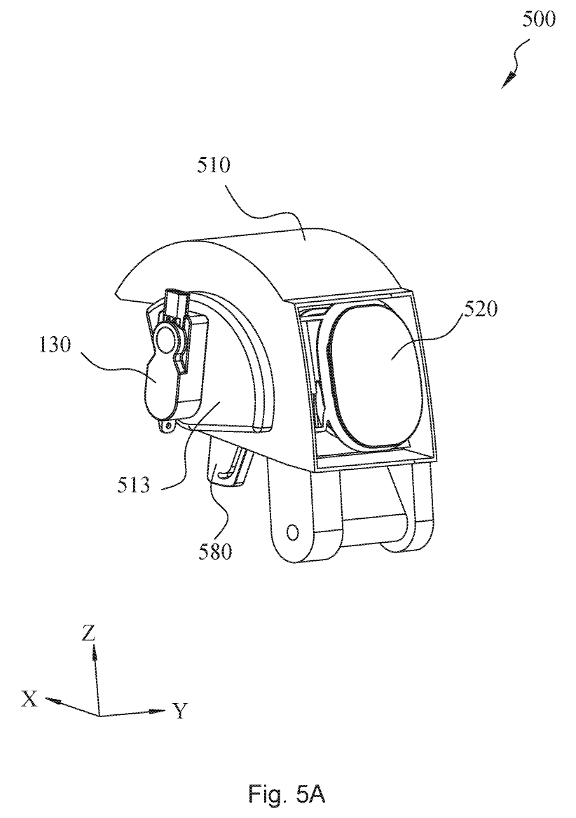

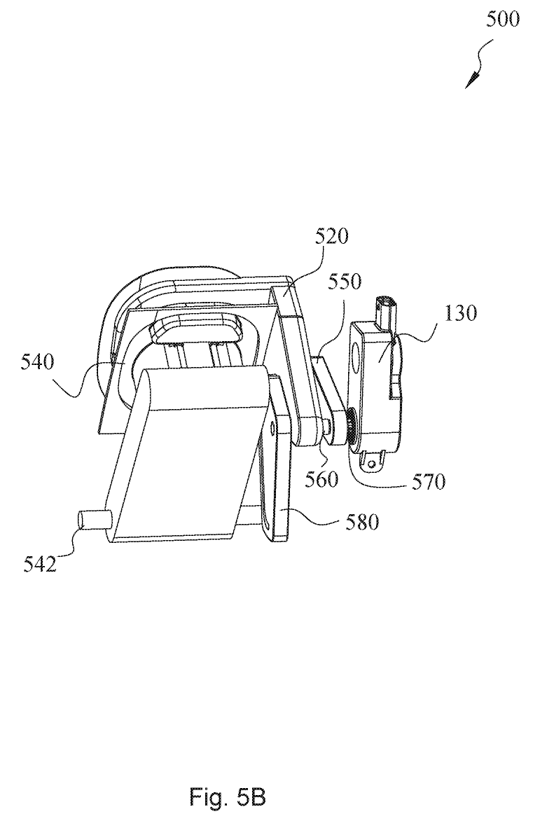

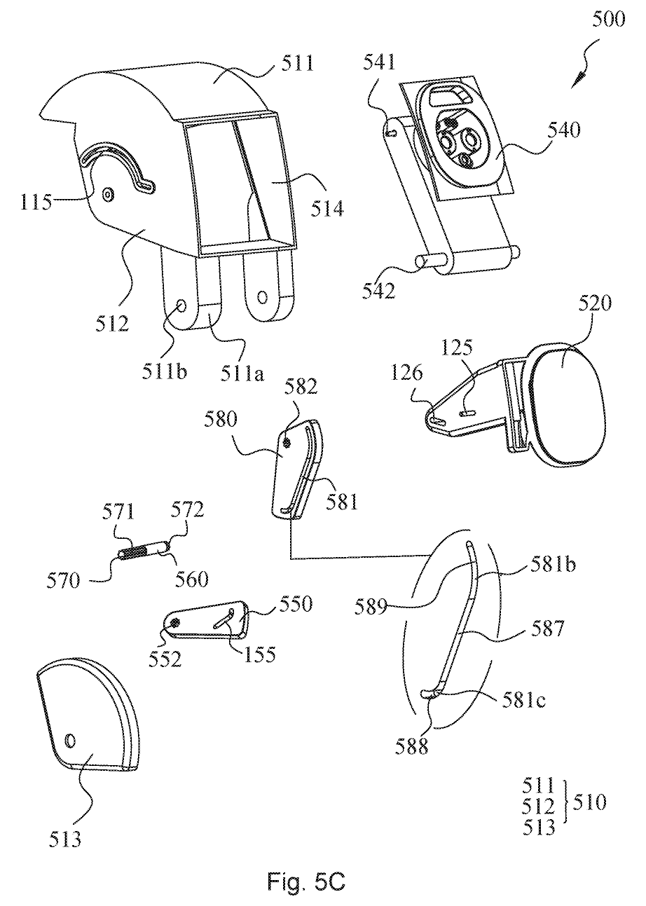

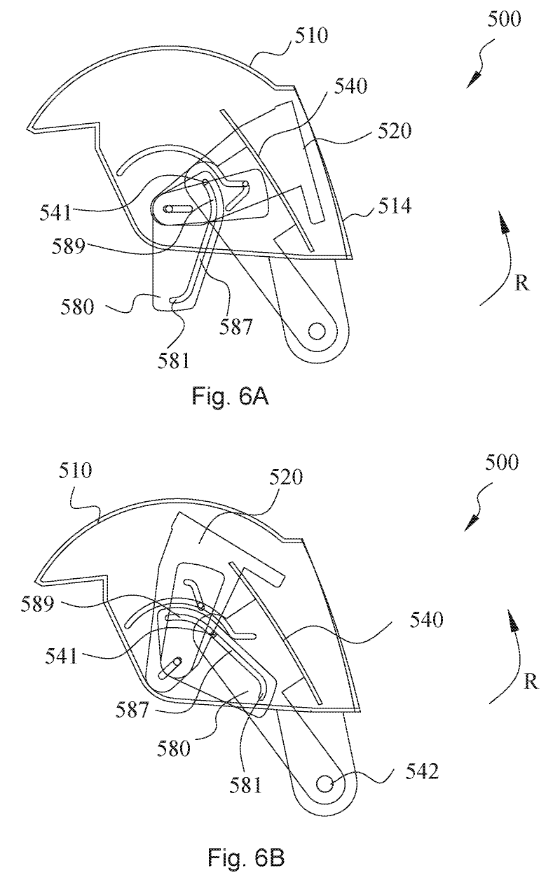

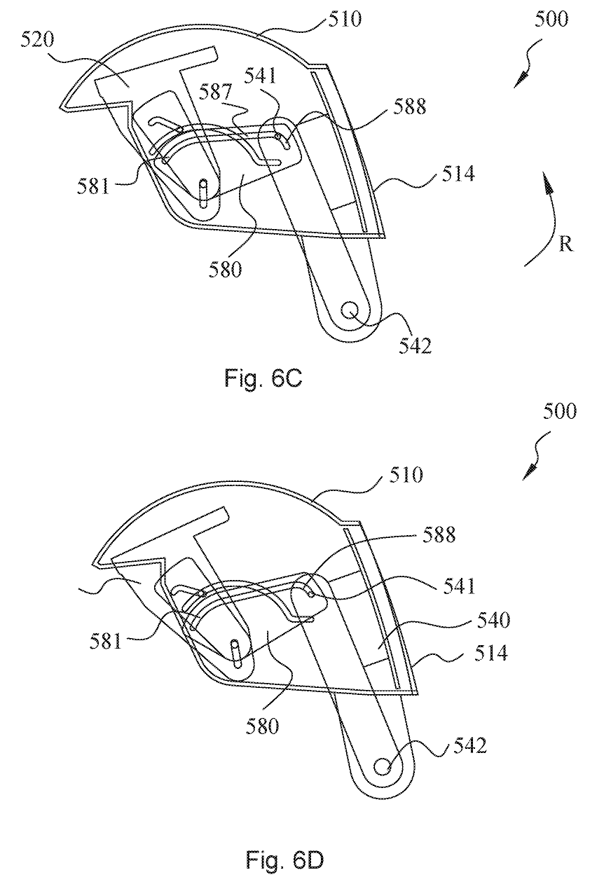

FIGS. 5A to 6D relate to a cover assembly 500 according to yet another exemplary embodiment of the present application. FIGS. 5A to 5C show a schematic overall structure of the cover assembly 500. FIGS. 6A to 6C schematically show the process of the cover 520 of the cover assembly 500 moving from the closed position to the open position while simultaneously the base 540 of the cover assembly 500 moves from a retracted position to an extended position.

FIG. 5A is a schematic front perspective view of the cover assembly 500. FIG. 5B is a schematic rear perspective view of the cover assembly 500, in which the housing 510 of the cover assembly 500 is omitted. FIG. 5C is a schematic exploded view of the cover assembly 500, in which the drive device 130 is omitted in FIG. 5C.

The manner in which the cover 520 of the cover assembly 500 is driven to move between the closed position and the open position is similar to that of the cover 120 in the cover assembly 100, and the structure of the cover assembly 500 for realizing the movement of the cover 520 is similar to the structure of the cover assembly 100 for realizing the movement of the cover 120. The substantive difference between the cover assembly 500 and the cover assembly 100 is that the base 540 of the cover assembly 500 is rotatable between a retracted position and an extended position, and accordingly, a base pusher 580 for driving the rotation of the base 540 is added. For the sake of brevity, the following description primarily focuses on the substantive differences in structure and movement between the cover assembly 500 and the cover assembly 100, while omitting or only briefly describing their similarities and non-substantive differences. The omitted or briefly described contents can be referred to in the description regarding the cover assembly 100.

Referring to FIGS. 5A to 5C, the cover assembly 500 includes a housing 510, a cover 520, a drive device 130, a base 540, a cover pusher 550, a support shaft 560, a drive shaft 570, and a base pusher 580.

The housing 510 defines a housing opening 514 and includes a main housing 511. A first side cover plate 512 is connected to the main housing 511. The housing 510 further includes a second side cover plate 513 disposed outside the first side cover plate 512. The first side cover plate 512 defines a first track groove 115 identical to that on the first side cover plate 112 of the housing 110 of the cover assembly 100, used to guide the cover 520 to move between the closed position and the open position based on the same principle and manner as those of the cover assembly 100. The main housing 511 is provided with mounting legs 511a, on which mounting holes 511b are defined for rotatably mounting the base 540.

The cover 520 is shown having a shape different from that of the cover 120 in the cover assembly 100. Nevertheless, it is provided with the same cover guide pin 125 and receiving groove 126 as those on the cover 120 and is driven to move between the closed position and the open position based on the same principle and manner as those of the cover 120.

The cover pusher 550 is provided with a second track groove 155 identical to that on the cover pusher 150 of the cover assembly 100 and, based on the same principle and manner as that of the cover pusher 150, drives the cover 520 to move between the closed position and the open position under the drive of the drive device 130. The cover pusher 550 differs from the cover pusher 150 only in that the cover pusher 550 is provided only with a shaft hole 552 for fixedly connecting to the drive shaft 570, and is not provided with a hole for coupling to the support shaft 560.

In the cover assembly 500, a front portion 571 of the drive shaft 570 is located outside the main housing 511, fixedly connected to the drive device 130, and inserted into the shaft hole 552 on the cover pusher 550 to fixedly connect with the cover pusher 550. A rear portion 572 of the drive shaft 570 extends into the interior of the main housing 511 and is fixedly connected to the base pusher 580. The support shaft 560 is in the form of a sleeve, sleeved between the front portion 571 and the rear portion 572 of the drive shaft 570, allowing the drive shaft 570 to rotate relative to the support shaft 560. The support shaft 560 is fixedly supported on the main housing 511. The drive device 130 drives the cover pusher 550 and the base pusher 580 to rotate simultaneously relative to the housing 510 by driving the drive shaft 570 to rotate. In this manner, when the cover 520 is driven to move towards the open position, the base 540 is driven to move towards the extended position, and when the cover 520 is driven to move towards the closed position, the base 540 is driven to move towards the retracted position. Therefore, when the cover 520 is in the open position, the base 540 is in the extended position, and when the cover 520 is in the retracted position, the base 540 is in the retracted position.

The base 540 is provided with a base shaft 542 for insertion into the mounting holes 511b on the mounting legs 511a of the housing 510, enabling the base 540 to be rotatably mounted to the housing 510 about the base shaft 542. The base 540 is also provided with a base guide pin 541 for operative connection to the base pusher 580.

The base pusher 580 is disposed inside the main housing 511. The base pusher 580 is provided with a shaft hole 582 for receiving the rear portion 572 of the drive shaft 570 to fixedly connect with the drive shaft 570. The base pusher 580 is further provided with a third track groove 581 for receiving the base guide pin 541 on the base 540. The base pusher 580, under the drive of the drive device 130, pushes the base 540 to rotate between the retracted position and the extended position.

The third track groove 581 on the base pusher 580 includes a third limit groove segment 588, a drive groove segment 587, and a third guide groove segment 589. The third limit groove segment 588 and the third guide groove segment 589 are connected to the two ends of the drive groove segment 587, respectively.

The drive groove segment 587 is used to cooperate with the base guide pin 541, enabling the base pusher 580 to push the base 540 to rotate relative to the housing 510 under the drive of the drive device 130. In the embodiment shown in the figure, the drive groove segment 587 is a substantially linear groove. In other embodiments, the drive groove segment 587 may be configured in other shapes, such as an arc-shaped groove, provided that the base pusher 580 can push the base 540 to rotate relative to the housing 510 through the cooperation of the drive groove segment 587 with the base guide pin 541.

When the base 540 is in the extended position, the base guide pin 541 is located in the third limit groove segment 588. The third limit groove segment 588 can prevent the base 540 from rotating about the base shaft 542 under an external force. In the embodiment shown in the figure, when the base 540 is in the extended position, the extension direction of the third limit groove segment 588 substantially passes through the center axes of the base guide pin 541 and the base shaft 542 (see FIG. 6D). In the embodiment shown in the figure, when the base guide pin 541 slides within the third limit groove segment 588, the base 540 remains stationary relative to the housing 510. In other embodiments, when the base guide pin 541 slides within the third limit groove segment 588, the base 540 may be pushed by the base pusher 580 to rotate relative to the housing 510.

When the base 540 is in the retracted position, the base guide pin 541 is located in the third guide groove segment 589. The third guide groove segment 589 is configured such that when the base pusher 580 is driven to rotate by the drive device 130, the third guide groove segment 589 can guide the base guide pin 541 to slide therein, and the base 540 remains stationary relative to the housing 510. This prevents interference between the base 540 and the cover 520 during their simultaneous movement.

The process of the base 540 moving from the retracted position to the extended position is described with reference to FIGS. 6A to 6D. During this process, the cover 520 is driven from the closed position to the open position in the same manner as shown in FIGS. 2A to 2C. For the sake of brevity, the movement of the cover 520 is not repeatedly described in the following description.

FIG. 6A is a schematic side view of the cover assembly 500 in a first state, in which the base pusher 580 is not driven to rotate and the base 540 is in the retracted position. FIG. 6B is a schematic side view of the cover assembly 500 in a second state, in which the base pusher 580 has been driven to rotate but the base 540 remains in the retracted position. FIG. 6C is a schematic side view of the cover assembly 500 in a third state, in which the base pusher 580 has been further driven to rotate and the base 540 reaches the extended position. FIG. 6D is a schematic side view of the cover assembly 500 in a fourth state, in which the base pusher 580 has been still further driven to rotate and the base 540 remains in the extended position.

As shown in FIG. 6A, when the base 540 is in the retracted position, the base 540 is located inside the housing 510 away from the housing opening 514. The base guide pin 541 is located at the starting point of the third guide groove segment 589 within the third track groove 581. FIG. 6A shows that when the base 540 is in the retracted position, the cover 520 is correspondingly in the closed position, closing the housing opening 514.

From FIG. 6A to FIG. 6B, the base pusher 580 rotates in the counterclockwise direction (arrow R) shown in the figure. Consequently, the third track groove 581 moves relative to the base guide pin 541, causing the base guide pin 541 to slide within the third guide groove segment 589 of the third track groove 581. When the state shown in FIG. 6B is reached, the base guide pin 541 has just arrived in the drive groove segment 587 of the third track groove 581. During the process from FIG. 6A to FIG. 6B, the base pusher 580 does not push the base 540 to rotate, and thus the base 540 remains stationary relative to the housing 510. Therefore, in the state shown in FIG. 6B, the base 540 is still in its retracted position.

During the process from FIG. 6A to FIG. 6B, the cover 520 is driven away from its closed position. That is to say, the cover 520 is driven to move before the base 540. Referring to the structure shown in FIG. 6A, if the cover 520 and the base 540 move simultaneously, their movements would interfere with each other. As described in connection with FIGS. 6A and 6B, the present application, by including the third guide groove segment 589 in the third track groove 581, enables that during the process from FIG. 6A to FIG. 6B, the cover 520 is driven to move while the base 540 remains stationary, thereby avoiding interference between the movements of the cover 520 and the base 540. Moreover, this method of avoiding interference does not require increasing the space of the housing 510. It should be understood that the third guide groove segment 589 is provided as needed. For example, in other embodiments where the prevention of interference between the movements of the cover 520 and the base 540 is not needed, the third guide groove segment 589 may not be provided.

From FIG. 6B to FIG. 6C, the base pusher 580 continues to rotate in the counterclockwise direction (arrow R) shown in the figure. Consequently, the third track groove 581 continues to move relative to the base guide pin 541, causing the base guide pin 541 to slide within the drive groove segment 587 of the third track groove 581. The cooperation between the base guide pin 541 and the drive groove segment 587 causes the base pusher 580 to push the base 540 to rotate about the base shaft 542 relative to the housing 510 towards the extended position. When the state shown in FIG. 6C is reached, the base guide pin 541 arrives at the junction between the drive groove segment 587 and the third limit groove segment 588 of the third track groove 581, and the base 540 reaches the extended position, close to the housing opening 514. During the process from FIG. 6B to FIG. 6C, the cover 520 is further driven away from its closed position.

From FIG. 6C to FIG. 6D, the base pusher 580 continues to rotate in the counterclockwise direction (arrow R) shown in the figure. Consequently, the third track groove 581 moves relative to the base guide pin 541, causing the base guide pin 541 to slide within the third limit groove segment 588 of the third track groove 581. When the state shown in FIG. 6D is reached, the base guide pin 541 arrives at the end point of the third limit groove segment 588. During the process from FIG. 6C to FIG. 6D, the base 540 remains stationary relative to the housing 510. Therefore, in the state shown in FIG. 6D, the base 540 remains in its extended position. During the process from FIG. 6C to FIG. 6D, the cover 520 is further driven and reaches its open position. Thus, when the cover 520 reaches the open position, the base 540 has already reached the extended position. It should be understood that the third limit groove segment 588 may be provided as needed. It should also be understood that in other embodiments, the third limit groove segment 588 may be configured to drive the base 540 to rotate relative to the housing 510, such that the base 540 reaches the extended position simultaneously as the cover 520 reaches the open position.

It should be understood that when the cover assembly 500 executes the movement process from FIG. 6D to FIG. 6A, the base 540 moves from the extended position to the retracted position, and the cover 520 moves from the open position to the closed position. It should also be understood that the cover assembly 300 can also utilize the rotatable base 540 and base pusher 580 as used in the cover assembly 500.

In the present application, the cooperation between the first track groove on the housing and the operation structure of the cover pusher prevents the cover from moving along the height and depth directions of the housing under an external force when the cover is in the closed position. Furthermore, the cover is arranged within the housing such that it cannot move along the width direction of the housing. Therefore, in the cover assembly according to the present application, the cover can be maintained in the closed position and is less likely to leave its closed position due to an undesired external force in any direction. In the present application, the base can extend or retract relative to the housing opening. When it is necessary to connect an external device to the base, the base moves to the extended position, facilitating connection with the external device.

In the present application, the movement of the base and the cover is driven by the same drive device, such that when the cover moves between the closed position and the open position, the base correspondingly moves between the retracted position and the extended position. Therefore, when the cover is in the open position, the base is in the extended position, or when the cover is in the closed position, the base is in the retracted position.

While the present disclosure has been described in connection with examples of the embodiments outlined above, various alternatives, modifications, variations, improvements, and/or substantial equivalents, whether known or that are or may be presently unforeseen, may become apparent to those having at least ordinary skill in the art. Additionally, the technical effects and/or technical problems described in this specification are exemplary and not limiting; therefore, the disclosure herein may be used to address other technical problems and have other technical effects. Accordingly, various changes may be made without departing from the spirit or scope of the present disclosure. Therefore, the present disclosure aims to include all known or earlier developed alternatives, modifications, variations, improvements, and/or substantial equivalents.

### Main Reference Numerals Description

100/300/500 Cover assembly

110/510 Housing

111/511 Main housing

112/512 First side cover plate

113/513 Second side cover plate

114/514 Housing opening

115 First track groove

115a First end of the first track groove

115b Connection point of the first track groove

115c Second end of the first track groove

116 Support shaft hole

117 Drive shaft hole

118 First limit groove segment of the first track groove

119 First guide groove segment of the first track groove

120/520 Cover

121 Main body portion

122 Mounting portion

125 Cover guide pin

126 Receiving groove

126a First end of the receiving groove

126b Second end of the receiving groove

130 Drive device

140/540 Base

150, 350/550 Cover pusher

154/354 Operation structure

155 Second track groove

155a First end of the second track groove

155b Connection point of the second track groove

155c Second end of the second track groove

156 Hole

158 Second limit groove segment of the second track groove

159 Second guide groove segment of the second track groove

160/560 Support shaft

170/570 Drive shaft

351 Body

355 Operation lever

358 Connection pin

511a Mounting leg

511b Mounting hole

541 Base guide pin

542 Base shaft

552 Shaft hole of the cover pusher

571 Front portion of the drive shaft

572 Rear portion of the drive shaft

580 Base pusher

581 Third track groove

587 Drive groove segment

588 Third limit groove segment

589. Third guide groove segment

What is claimed is:

1. A cover assembly comprising:
a housing having a housing opening and having a height direction and a depth direction, the housing defining a first track groove;
a cover coupled to the housing through the first track groove and configured to move along the height direction and the depth direction between a closed position and an open position under the guidance of the first track groove to close or open the housing opening; and
a cover pusher provided with an operation structure and operatively connected to the cover through the operation structure to push the cover to move between the closed position and the open position under the drive of a drive device;
wherein the first track groove comprises a first limit groove segment configured to prevent the cover from moving along the height direction of the housing under an external force when the cover is in the closed position; and
wherein the operation structure is configured to prevent the cover from moving along the depth direction of the housing under an external force when the cover is in the closed position.

2. The cover assembly according to claim 1, wherein the first track groove further comprises a first guide groove segment connected to the first limit groove segment and configured to guide the cover to rotate relative to the housing.

3. The cover assembly according to claim 2, wherein the first limit groove segment extends substantially along the depth direction of the housing; and wherein the first guide groove segment is an arc-shaped groove.

4. The cover assembly according to claim 3, wherein the cover comprises:
a mounting portion, the cover being operatively connected to the operation structure of the cover pusher through the mounting portion; and
a main body portion connected to the mounting portion and shape-matched to the housing opening.

5. The cover assembly according to claim 4,
wherein the housing is provided with a support shaft, the cover pusher being rotatably supported on the housing through the support shaft; and
wherein the mounting portion of the cover is provided with a receiving groove, in which the support shaft is received, the receiving groove extending a certain length in a radial direction of the support shaft to allow the cover to move relative to the housing.

6. The cover assembly according to claim 5,
wherein the mounting portion of the cover is further provided with a cover guide pin, the cover guide pin being received in the first track groove and operatively connected to the operation structure of the cover pusher;
wherein, when the cover is in the closed position, the cover guide pin is located in the first limit groove segment of the housing, and when the cover is in the open position, the cover guide pin is located in the first guide groove segment of the housing.

7. The cover assembly according to claim 6,
wherein the operation structure comprises a second track groove, the second track groove receiving the cover guide pin and having a second limit groove segment and a second guide groove segment connected to each other; and
wherein, when the cover is in the closed position, the cover guide pin is located in the second limit groove segment, and when the cover is in the open position, the cover guide pin is located in the second guide groove segment.

8. The cover assembly according to claim 7,
wherein the second limit groove segment extends substantially along the height direction of the housing; and
wherein the second guide groove segment extends from the second limit groove segment in a direction away from the housing opening to allow the cover guide pin to move from the first limit groove segment of the housing towards the first guide groove segment of the housing under the drive of the drive device.

9. The cover assembly according to claim 6,
wherein the operation structure comprises an operation lever, the operation lever being rotatably connected to the cover pusher via a connection pin and fixedly connected to the cover guide pin;
wherein, when the cover is in the closed position, the central axes of the support shaft, the connection pin and the cover guide pin are substantially located at the same position in the height direction of the housing to prevent the cover from moving along the depth direction of the housing under an external force.

10. The cover assembly according to claim 1, further comprising:
a base rotatably mounted to the housing about a base shaft to have an extended position and a retracted position relative to the housing opening.

11. The cover assembly according to claim 10, further comprising:
a base pusher operatively connected to the drive device and the base to rotate relative to the housing simultaneously with the cover pusher under the drive of the drive device and to push the base to rotate.

12. The cover assembly according to claim 11,
wherein the base pusher is provided with a third track groove comprising a drive groove segment; and
wherein the base is provided with a base guide pin, the base guide pin being received in the third track groove and cooperating with the drive groove segment to enable the base pusher to push the base to rotate.

13. The cover assembly according to claim 12, wherein the third track groove further comprises a third limit groove segment connected to one end of the drive groove segment, the third limit groove segment being configured to prevent the base from rotating relative to the housing under an external force when the base is in the extended position.

14. The cover assembly according to claim 13, wherein when the base is in the extended position, an extension direction of the third limit groove segment substantially passes through the central axes of the base guide pin and the base shaft.

15. The cover assembly according to claim 13, wherein the third track groove further comprises a third guide groove segment connected to the other end of the drive groove segment, the third guide groove segment being configured to guide the base guide pin to slide therein when the base pusher is driven to rotate by the drive device while the base remains stationary relative to the housing.

16. The cover assembly according to claim 1, wherein the cover assembly comprises the drive device mounted to the housing.

17. A cover assembly comprising:
a housing having a housing opening;
a base rotatably mounted to the housing about a base shaft to have an extended position and a retracted position relative to the housing opening; and
a base pusher operatively connected to the base to push the base to rotate under the drive of a drive device.

18. The cover assembly according to claim 17,
wherein the base pusher is provided with a third track groove comprising a drive groove segment; and
wherein the base is provided with a base guide pin, the base guide pin being received in the third track groove and cooperating with the drive groove segment to enable the base pusher to push the base to rotate.

19. The cover assembly according to claim 18, wherein the third track groove further comprises a third limit groove segment connected to one end of the drive groove segment, the third limit groove segment being configured to prevent the base from rotating relative to the housing under an external force when the base is in the extended position.

20. The cover assembly according to claim 19, wherein when the base is in the extended position, an extension direction of the third limit groove segment substantially passes through the central axes of the base guide pin and the base shaft.
